(19) United States
(12) Patent Application Publication
(10) Pub. No.: US 2026/0131534 A1
(43) Pub. Date: May 14, 2026

(54) System and Method for Creating Personalized Memorial Statues of Deceased Pets

(71) Applicant: Jacquelyn Bell, Iron Ridge, WI (US)

(72) Inventor: Jacquelyn Bell, Iron Ridge, WI (US)

(21) Appl. No.: 19/032,332

(22) Filed: Jan. 20, 2025

Related U.S. Application Data
(60) Provisional application No. 63/622,254, filed on Jan. 18, 2024.

(51) Int. Cl. B29C 64/386; B29C 64/118; B29K 55/02; B29K 67/00; B29K 105/16; B33Y 30/00; B33Y 50/00; B33Y 80/00

(52) U.S. Cl. CPC B29C 64/386; B29C 64/118; B33Y 30/00; B33Y 50/00; B33Y 80/00; B29K 2055/02; B29K 2067/003; B29K 2067/046; B29K 2105/16

(57) ABSTRACT

A system and method for memorializing deceased pets by creating 3D-printed statues incorporating the pet's cremated ashes is disclosed. The system includes a 3D modeling module configured to receive high-resolution digital images of the pet to generate a detailed 3D model using a pre-trained software that captures unique pet features. The system also features a 3D printer that uses a filament formed using the pet's ashes with a base material such as PLA, ABS, PETG, or nylon. The filament enables for the creation of durable and lifelike statues in various sizes. Additionally, the system includes an interface for user feedback and customization options, including selecting the size, pose, and final appearance of the statue. A painting module is provided for adding colors and texture details to the 3D-printed statue. The invention offers a unique and personalized way to remember deceased pets, enhancing traditional memorial practices.

### CROSS-REFERENCE TO RELATED APPLICATION

The present application claims priority to, and the benefit of, U.S. Provisional Application No. 63/622,254, which was filed on Jan. 18, 2024, and is incorporated herein by reference in its entirety.

### FIELD OF THE INVENTION

The present invention generally relates to the field of 3D-printing devices. More specifically, the present invention relates to a novel system for making a 3D statue of a deceased pet. The system uses a 3D printer having a filament that contains the pet's cremated ashes along with a base material. The size of the statue or figurine can range from shelf size to actual size and is made using a 3D model created from one or more digital images of the deceased pet. Accordingly, the present disclosure makes specific reference thereto. Nonetheless, it is to be appreciated that aspects of the present invention are also equally applicable to other like applications, devices, and methods of manufacture.

### BACKGROUND

By way of background, losing a pet can be an extremely difficult and emotional experience for pet owners. Pets are often considered beloved members of the family, and their passing leaves a significant void in their owners'lives. Traditionally, pet owners memorialize their deceased pets by collecting the remains in a specialized box or urn, which is then displayed on a shelf. The conventional memorialization method provides a way to keep the pet's memory alive, but the urn or box is often plain and lacks personalization, which can lead to sadness and a sense of emptiness whenever it is seen.

Additionally, the traditional urns are static, cannot be customized and may not fully capture the vibrant and cherished memories that pet owners have of their pets. Individuals may put pictures and paintings but they do not include the remains of the pet. As a result, there is a growing demand for more personalized and meaningful ways to memorialize beloved pets. Pet owners desire innovative solutions that not only honor their pets'memories but also provide comfort and a sense of connection.

Therefore, there exists a long felt need in the art for an improved way of pet memorialization. There is also a long felt need in the art for a novel pet memorialization method through creation of 3D-printed statues that incorporate the pet's cremated ashes. Additionally, there is a long felt need in the art for a unique system that enables for the creation of detailed and lifelike statues that capture the unique features and personality of the pet. Moreover, there is a long felt need in the art for a more interactive and visually appealing memorial. Further, there is a long felt need in the art for a unique and personalized memorial to remember deceased pets, enhancing traditional memorial practices. Furthermore, there is a long felt need in the art for an enhanced deceased pet memorial that includes ashes with a base material. Finally, there is a long felt need in the art for a uniquely designed memorial and a system that memorialize deceased pets by creating statues or figurines that incorporate the pet's cremated ashes.

The subject matter disclosed and claimed herein, in one embodiment thereof, comprises a system for memorializing deceased pets by producing statues and figurines. The system includes a 3D modeling module configured to receive a plurality of high-resolution digital images of a pet and generate a 3D model of the pet using a 3D modeling software, wherein the 3D modeling software is pre-trained to capture unique features of different types of pets. A 3D printer is coupled to the 3D modeling module, the 3D printer is adapted to use a filament that incorporates cremated ashes of the pet mixed with a base material to create a 3D-printed statue of the pet. A painting module is configured to paint the 3D-printed statue to resemble the pet and an interface enables a user to provide input and feedback on the size, pose, and color of the 3D-printed statue. The statue can be of different shape, size, and color and includes deceased pets'ashes.

In this manner, the system for memorializing deceased pets and the associated memorial of the present invention accomplishes all of the forgoing objectives and memorialize deceased pets by creating statues or figurines that incorporate the pet's cremated ashes. The memorial offers pet owners a unique way to remember their pets. The use of 3D printing technology to create personalized memorials that incorporate the pet's ashes provides touching and personalized approach to pet remembrance. The system enables for the creation of detailed and lifelike statues that capture the unique features and personality of the pet, providing a more interactive and visually appealing memorial.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for memorializing deceased pets. The system includes a 3D modeling module configured to receive a plurality of high-resolution digital images of a pet and generate a 3D model of the pet using a 3D modeling software, wherein the 3D modeling software is pre-trained to capture unique features of different types of pets. A 3D printer is coupled to the 3D modeling module, the 3D printer is adapted to use a filament that incorporates cremated ashes of the pet mixed with a base material to create a 3D-printed statue of the pet. A painting module is configured to paint the 3D-printed statue to resemble the pet and an interface enables a user to provide input and feedback on the size, pose, and color of the 3D-printed statue.

In yet another embodiment, a memorial statue of a deceased pet is disclosed. The statue includes a 3D-printed structure created using the cremated ashes of the deceased pet and a base material selected from the group consisting of polylactic acid (PLA), acrylonitrile butadiene styrene (ABS), polyethylene terephthalate glycol (PETG), and nylon, an external surface of the 3D-printed structure is painted to resemble the natural appearance of the pet, and wherein the statue can be customized in size and pose according to the preferences of the pet's owner.

In yet another embodiment, a method for creating a memorial statue of a deceased pet is described. The method includes the steps of receiving a plurality of high-resolution digital images of the pet, wherein the digital images include various angles to capture the full shape and contours of the pet, generating a 3D model of the pet using a 3D modeling module that processes the received digital images with a 3D modeling software pre-trained to capture unique features of different types of pets, creating a filament for 3D printing by grinding the cremated ashes of the pet uniformly and mixing the ashes with a base material, printing a 3D statue of the pet using a 3D printer and the created filament, and painting the 3D-printed statue to resemble the pet. The 3D modeling software is configured to create a 3D model in a specific pose and alignment based on the input digital images.

In another embodiment, the filament is in the form of a spool upon which a length of plastic is wrapped or wound and the digital images have a minimum resolution of at least 3000×3000 pixels.

In another aspect, a system for creating 3D statues of deceased pets is disclosed. The system includes a 3D modeling module configured to receive a plurality of high-resolution digital images of a pet and generate a detailed 3D model of the pet using a 3D modeling software, wherein the 3D modeling software is pre-trained to capture unique features of different types of pets and create a 3D model in a specific pose and alignment based on the input digital images, a 3D printer coupled to the 3D modeling module, the 3D printer being adapted to use a filament that incorporates cremated ashes of the pet mixed with a base material selected from the group consisting of polylactic acid (PLA), acrylonitrile butadiene styrene (ABS), polyethylene terephthalate glycol (PETG), and nylon to create a 3D-printed statue of the pet, and an interface configured to enable a user to select the size and pose of the 3D-printed statue and to provide feedback on the appearance of the 3D-printed statue.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of deceased pets'memorialization system of the present invention in accordance with the disclosed structure;

FIG. 2 illustrates a perspective view of a 3D-printed statues of a pet using the 3D-printing system of the present invention in accordance with the disclosed structure;

FIG. 3 illustrates a flow diagram depicting a process of manufacturing 3D-statues of deceased pets, according to the embodiments as disclosed therein;

FIG. 4 illustrates a perspective view of a customized urn made by the 3D-printing system of the present invention in accordance with the disclosed structure; and

FIG. 5 illustrates a perspective view of a small figurine prepared using the 3D-printing system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved way of pet memorialization. There is also a long felt need in the art for a novel pet memorialization method through creation of 3D-printed statues that incorporate the pet's cremated ashes. Additionally, there is a long felt need in the art for a unique system that enables for the creation of detailed and lifelike statues that capture the unique features and personality of the pet. Moreover, there is a long felt need in the art for a more interactive and visually appealing memorial. Further, there is a long felt need in the art for a unique and personalized memorial to remember deceased pets, enhancing traditional memorial practices. Furthermore, there is a long felt need in the art for an enhanced deceased pet memorial that includes ashes with a base material. Finally, there is a long felt need in the art for a uniquely designed memorial and a system that memorialize deceased pets by creating statues or figurines that incorporate the pet's cremated ashes.

The present invention, in one exemplary embodiment, is a memorial statue of a deceased pet. The statue includes a 3D-printed structure created using the cremated ashes of the deceased pet and a base material selected from the group consisting of polylactic acid (PLA), acrylonitrile butadiene styrene (ABS), polyethylene terephthalate glycol (PETG), and nylon, an external surface of the 3D-printed structure is painted to resemble the natural appearance of the pet, and wherein the statue can be customized in size and pose according to the preferences of the pet's owner. The statue can be of different shapes, sizes, and colors.

Reference will now be made in detail to the present preferred embodiments of the invention, examples of which are illustrated in the accompanying drawings. Wherever possible, the same reference numerals are used in the drawings and the description to refer to the same or like parts.

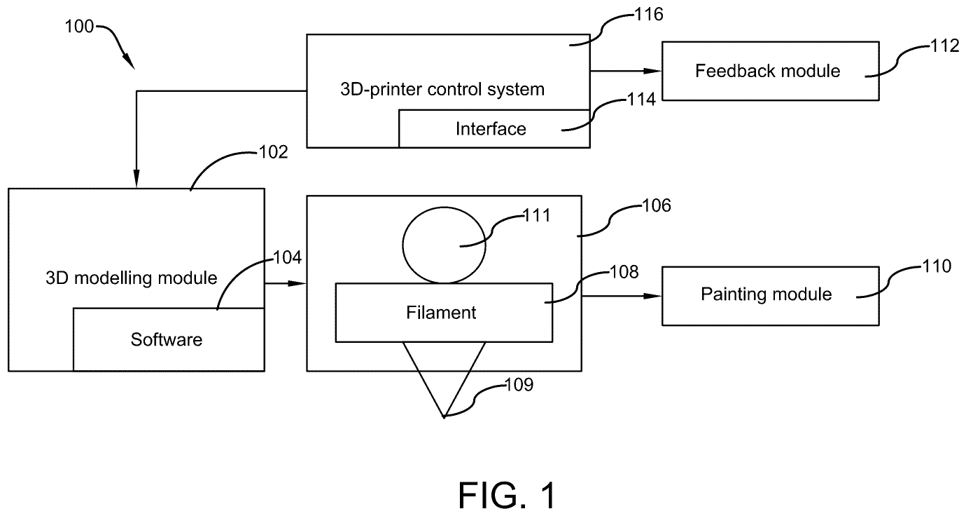

Referring initially to the drawings, FIG. 1 illustrates a diagram view of deceased pets'memorialization system of the present invention in accordance with the disclosed structure. The memorialization system for deceased pets 100 of the present invention is designed as an innovative system to memorialize deceased pets by creating statues or figurines that incorporate the pet's cremated ashes. The system 100 is adapted to incorporate the ashes of deceased pets into 3D-printed statues. More specifically, the system 100 includes a 3D modelling module 102 which is configured to take high-resolution of photos of a pet for creating a 3D model. The 3D modelling module 102 can receive a plurality of digital images to capture the pet's unique features, colors, and likeness. The 3D modelling module 102 includes a unique 3D modelling software 104 for processing the photos and generating a detailed 3D model of the pet. The 3D modelling software 104 is pre-trained on different types of pets such as cats, dogs, and more and is uniquely designed to capture features from images. The 3D modelling software 104 can also be configured to create a 3D model in a specific pose and alignment based on the input digital images. The 3D modelling module 102 can be a microcomputer or a computing device which is designed for 3D modelling of pet images.

A 3D printer 106 with a unique 3D printing filament 108 is coupled to the module 102. The filament 108 is uniquely created and cremated ashes of a pet are mixed with a base material to create the filament 108. Preferably, the base material can include plastic polymers for making the 3D-printed entity durable. More preferably, the filament 108 can be made of one from polylactic acid (PLA), acrylonitrile butadiene styrene (ABS), polyethylene terephthalate glycol (PETG), and nylon. The filament 108 is durable and solid to be used with the 3D printer 106. The printer 106 is calibrated to handle the unique material properties of the ashes-infused filament. The filament 108 is heated up by a heated extrusion nozzle 109 into a semi-liquid state and is used to build a 3D-printed statue layer by layer based on the 3D model of the pet. The filament 108 can be used for creating statues of different sizes ranging from small, shelf-sized figurines to life-sized replicas, depending on the pet owner's preference and the amount of ashes available. The filament 108 can be in the form of a spool 111 upon which is wrapped or wound a length of plastic designed to prevent or limit 3D scanning.

A painting module 110 is included in the system 100 for painting the 3D-printed model or statue. The colors by painting module 110 add color and details, bringing the statue to life. The natural color of the filament 108 can be neutral such white and grey to facilitate easy painting and customization of the 3D-printed model after printing. A feedback module 112 of the system 100 enables a user such as owner of the deceased pet to give the feedback on size, pose, color, and more of the 3D-printed module. It will be apparent to a person skilled in the art that the system 100 can provide an interface 114 of a 3D-printer control system 116 for enabling selection of pose, alignment, color, and providing feedback to the system 100. The system 100 provides pet owners a unique way to remember their pets.

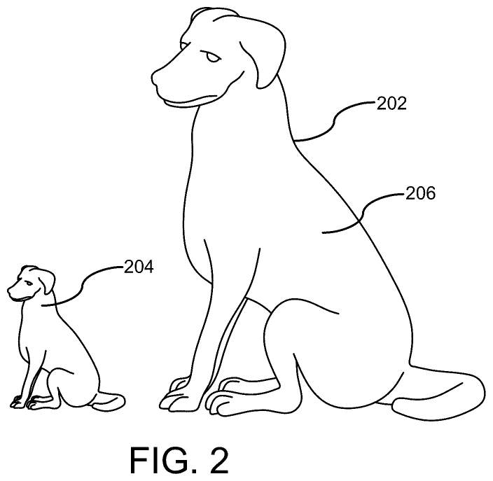

FIG. 2 illustrates a perspective view of a 3D-printed statues of a pet using the 3D-printing system of the present invention in accordance with the disclosed structure. As illustrated, the 3D-printed statues 202, 204 are made of ashes of a deceased pet using the system 100. The system 100 is configured to make a plurality of 3D statues of different sizes depending on the quantity of ashes. The size of the statues can be preconfigured using the interface 114 for adapting the printer 106 and the filament 108. The statues made by the system 100 offer high degree of personalization and lifelike appearance help maintain a connection with the deceased pet. The outer surface 206 of the statues 202, 204 can be textured to give a lifelike appearance of the deceased pet.

The system 100 can be designed for both professional and personal applications. In one embodiment, the system 100 can be used commercially for manufacturing 3D-statues for deceased pets. In such a case, the interface 114 can be provided via a mobile application or a website which can be accessed on a browser. Alternatively, the interface 114 may not be required in the system 100 of small sizes and the system 100 can be preconfigured with a specific size and for a specific pet.

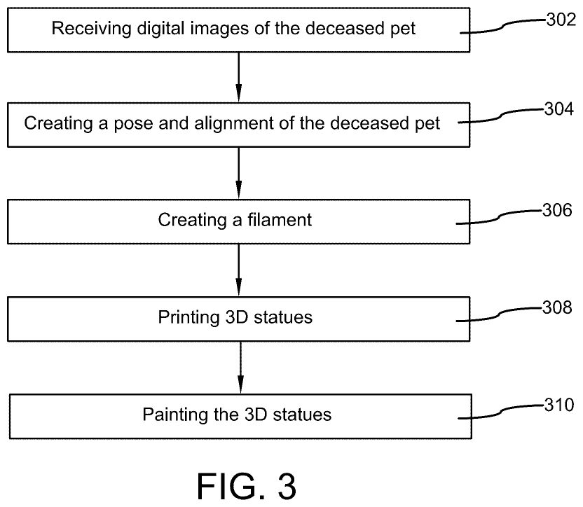

FIG. 3 illustrates a flow diagram depicting a process of manufacturing 3D-statues of deceased pets, according to the embodiments as disclosed therein. Initially, a plurality of Hi-definition digital images having minimum resolution of at least 3000×3000 pixels is received by the system (Step 302). Preferably, the digital images will have pixel dimensions of 5000×5000 pixels or more. Further, the images should include various angles (front, sides, back, top) to capture the full shape and contours of the pet. High-quality image file formats such as RAW, TIFF, or high-resolution JPEGs can be received by the system 100 for creating 3D-models.

Then, in the next step 304, the 3D modelling software 104 of the module 102 helps in creating a pose and alignment to show the full contour and appearance of the deceased pet and the module 102 creates a 3D model. In some cases, a plurality of models are created and the owner of the deceased pet can select one of the models for 3D printing.

Thereafter, a filament is created for 3D printing and the ashes are ground uniformly and mixed with a base material for effective extrusion through 3D printer nozzle (Step 306). The base material can be chosen based on size of the statue and quantity of the ashes. Once the filament is made, 3D statues are printed using the filament (Step 308) and real-time updates can be sent to the deceased pet owner. Once the 3D statue is made, the painting can be completed in the likeness of the deceased pet (i.e., using the digital images of the pet) and the statue is finalized for placement in a house or any other area (Step 310).

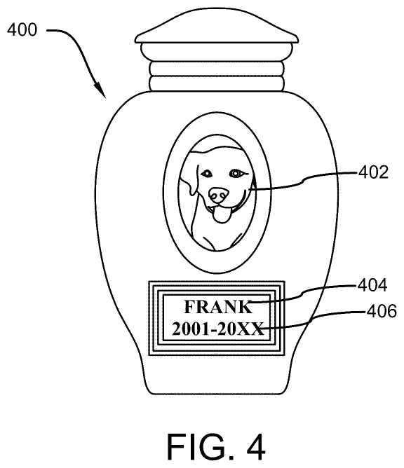

FIG. 4 illustrates a perspective view of a customized urn made by the 3D-printing system of the present invention in accordance with the disclosed structure. The urn 400 of the present embodiment is created by the system 100 using the ashes of the deceased pet. The urn 400 can be customized by including a 3D-printed image 402, name 404 and lifeline 406 of the deceased pet for remembrance and personalization.

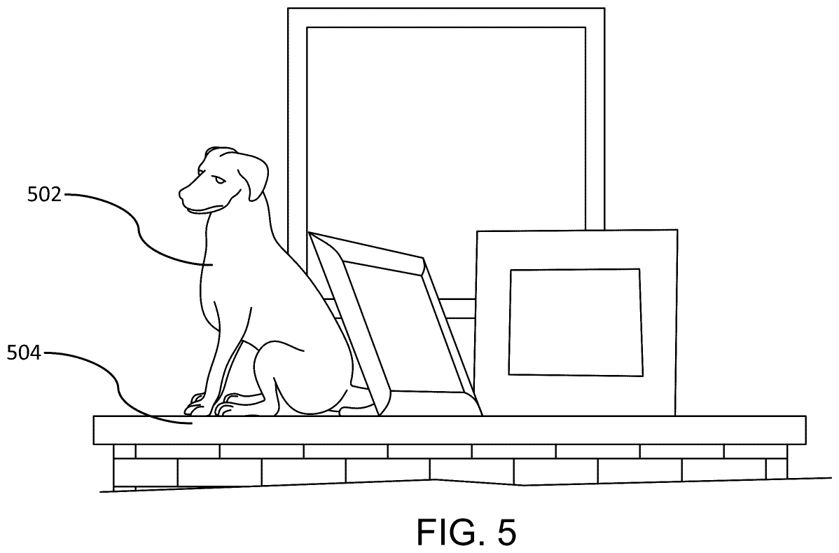

FIG. 5 illustrates a perspective view of a small figurine prepared using the 3D-printing system of the present invention in accordance with the disclosed structure. The figurine 502 of a deceased pet is prepared using the same printing system 100 for placement on a shelf 504. The figurine 502 is preferably unbreakable and can be made in different sizes.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “memorialization system for deceased pets”, “deceased pets'memorialization system”, “3D-printing system”, and “system” are interchangeable and refer to the memorialization system for deceased pets 100 of the present invention.

Notwithstanding the forgoing the memorialization system for deceased pets 100 of the present invention can be of any suitable size and configuration as is known in the art without affecting the overall concept of the invention, provided that it accomplishes the above stated objectives. One of ordinary skill in the art will appreciate that the memorialization system for deceased pets 100 as shown in the FIGS. are for illustrative purposes only, and that many other sizes and shapes of the memorialization system for deceased pets 100 are well within the scope of the present disclosure. Although the dimensions of the memorialization system for deceased pets 100 are important design parameters for user convenience, the memorialization system for deceased pets 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A memorialization system for deceased pets, the memorialization system comprising:
a 3D modelling module;
a plurality of digital images of a pet;
a 3D printer;
a 3D printing filament;
a deceased pet's ashes;
wherein said 3D modelling module receiving said plurality of digital images of the pet;
wherein said 3D modelling module having a conversion software for processing said plurality of digital images and generating a 3D model of the pet from said plurality of digital images;
wherein said 3D printing filament including said deceased pet's ashes;
wherein said deceased pet's ashes mixed with a base material to form said 3D printing filament; and
further wherein said 3D printing filament builds a layered 3D-printed statue of said 3D model of the pet.

2. The memorialization system for deceased pets of claim 1, wherein said base material including a plastic polymer.

3. The memorialization system for deceased pets of claim 2, wherein said 3D printing filament including a material selected from the group consisting of a polylactic acid (PLA), a acrylonitrile butadiene styrene (ABS), a polyethylene terephthalate glycol (PETG), and a nylon.

4. The memorialization system for deceased pets of claim 3 further comprising a painting module for painting said 3D-printed statue.

5. The memorialization system for deceased pets of claim 4 further comprising a feedback module for an owner of the pet to give feedback on a number of parameters selected from the group consisting of a size, a pose, an alignment, and a color.

6. The memorialization system for deceased pets of claim 5, wherein said feedback module having an interface for the owner to control said number of parameters.

7. The memorialization system for deceased pets of claim 6, wherein said interface having a mobile application accessible on a browser.

8. The memorialization system for deceased pets of claim 7, wherein said plurality of digital images of the pet include Hi-definition digital images having minimum resolution of at least 3000×3000 pixels.

9. The memorialization system for deceased pets of claim 7, wherein said plurality of digital images of the pet include Hi-definition digital images having minimum resolution of at least 5000×5000 pixels.

10. A memorialization system for deceased pets comprising:
a 3D modelling module;
a plurality of digital images of a pet;
a 3D printer;
a 3D printing filament;
a deceased pet's ashes;
a feedback module;
wherein said 3D modelling module receiving said plurality of digital images of the pet;
wherein said 3D modelling module having a conversion software for processing said plurality of digital images and generating a 3D model of the pet from said plurality of digital images;
wherein said 3D printing filament including said deceased pet's ashes;
wherein said deceased pet's ashes uniformly ground and mixed with a base material to form said 3D printing filament;
wherein said feedback module accessible by an owner of the pet to give feedback on a number of parameters selected from the group consisting of a size, a pose, an alignment, and a color; and
further wherein said 3D printing filament builds a layered 3D-printed statue of said 3D model of the pet.

11. The memorialization system for deceased pets of claim 10, wherein said base material including a plastic polymer.

12. The memorialization system for deceased pets of claim 10, wherein said 3D printing filament including a material selected from the group consisting of a polylactic acid (PLA), a acrylonitrile butadiene styrene (ABS), a polyethylene terephthalate glycol (PETG), and a nylon.

13. The memorialization system for deceased pets of claim 10 further comprising a painting module for painting said 3D-printed statue.

14. The memorialization system for deceased pets of claim 10, wherein said feedback module having an interface for the owner to control said number of parameters.

15. The memorialization system for deceased pets of claim 14, wherein said interface having a mobile application accessible on a browser.

16. The memorialization system for deceased pets of claim 10, wherein said plurality of digital images of the pet include Hi-definition digital images having minimum resolution of at least 5000×5000 pixels.

17. A memorialization system for deceased pets comprising:
a 3D modelling module;
a plurality of digital images of a pet;
a 3D printer;
a 3D printing filament;
a deceased pet's ashes;
a feedback module;
a painting module;
wherein said 3D modelling module receiving said plurality of digital images of the pet;
wherein said 3D modelling module having a conversion software for processing said plurality of digital images and generating a 3D model of the pet from said plurality of digital images;
wherein said 3D printing filament including said deceased pet's ashes;
wherein said deceased pet's ashes uniformly ground and mixed with a base material to form said 3D printing filament;
wherein said feedback module accessible by an owner of the pet to give feedback on a number of parameters selected from the group consisting of a size, a pose, an alignment, and a color;
wherein said 3D printing filament builds a layered 3D-printed statue of said 3D model of the pet; and
further wherein said painting module for painting said 3D-printed statue in a likeness of the pet.

18. The memorialization system for deceased pets of claim 17, wherein said feedback module having an interface for the owner to control said number of parameters.

19. The memorialization system for deceased pets of claim 18, wherein said interface having a mobile application accessible on a browser.

20. The memorialization system for deceased pets of claim 17, wherein said 3D-printed statue is an urn.
